(19) United States
(12) Patent Application Publication
(10) Pub. No.: US 2017/0239839 A1
(43) Pub. Date: Aug. 24, 2017

(54) SYSTEM AND METHOD FOR FORMING PREFABRICATED BUILDING PANELS

(71) Applicant: Form Brick Pty Ltd, Malvern, Victoria (AU)

(72) Inventors: Charles N. Gubbins, Malvern, Victoria (AU); William S. Findlay, Randwick, New South Wales (AU)

(21) Appl. No.: 15/315,284

(22) PCT Filed: Jun. 2, 2015
(86) PCT No.: PCT/AU2015/050302

§ 371 Date: Nov. 30, 2016

(30) Foreign Application Priority Data
Jun. 3, 2014 (AU) 2014902116

(51) Int. Cl. B28B 19/00; E04F 13/14; E04G 9/10; B28B 7/00; B28B 1/16

(52) U.S. Cl. CPC B28B 19/0061; B28B 7/0017; B28B 1/16; E04G 9/10; E04F 13/147; E04G 15/02

(57) ABSTRACT

A system, comprising: at least one planar member having a two- or three-dimensional surface pattern formed thereon or therein; and a plurality of resilient spacers removably positionable on or in the surface pattern to form a surface relief pattern of spaced-apart recesses on the at least one planar member.

### FIELD

The present invention relates to a system and method for forming prefabricated building panels.

### BACKGROUND

Prefabricated building panels are commonly formed with surface relief patterns of architectural components or masonry items, such as bricks, tiles, mosaics, stone, glass, etc. Such panels are typically formed by casting concrete over architectural components prepositioned in spaced-apart recesses in formliners or moulds made from rubber-like polyurethane elastomers, or plastic formliner sheets. Alternatively, the architectural components may be omitted so that the surface relief pattern is formed by casting concrete directly into the recesses in the moulds to form a surface relief pattern that mimics the three-dimensional shape of architectural components.

Existing formliner systems have various disadvantages. Most of them are either single use, or are prohibitively expensive such as custom made moulds.

In this context, it is desirable to provide that a system and method for forming prefabricated building panels that addresses or at least partially ameliorates one or more of the problems discussed above.

### SUMMARY

According to the present invention, there is provided a system, comprising:

at least one planar member having a two- or three-dimensional surface pattern formed thereon or therein; and

a plurality of resilient spacers removably positionable on or in the surface pattern to form a surface relief pattern of spaced-apart recesses on the at least one planar member.

The at least one planar member may comprise a horizontal planar member and a plurality of vertical planar members arranged in or around the horizontal planar member to form a mould for receiving concrete.

The surface pattern may comprise slots, and the resilient spacers may comprise ribs removably receivable in the slots. Alternatively, the surface pattern may comprise surface markings, and the resilient spacers may comprise self-adhesive ribs removably positionable on the surface markings.

The slots and the resilient spacers may have complementary releasably interlocking configurations.

Each resilient spacer may comprise a head and a base, wherein the head is configured to resiliently and sealingly compress against a horizontally adjacent one of the planar architectural components, and wherein the base is configured to be anchored in a vertically adjacent one of the slots. For example, the head may have a hollow semi-circular or semi-elliptical cross-section, and the base may comprise one or more pairs of upward angled barbs.

The resilient spacers may be slidably receivable in the slots. Alternatively, the resilient spacers may be removably receivable in the slots by press fitting or friction fitting.

The resilient spacers may be cut from a strip of resilient material of indeterminate length.

The resilient spacers may be formed from a rubber, plastic or foam resilient material that is flexible, elastic, durable and releasable from concrete. The resilient spacers may further comprise a substantially rigid spine. For example, the head and the base of each resilient spacer may be co-extruded, wherein the head is formed of thermoplastic vulcanizate (TPV), and the base is formed of polypropylene.

The at least one planar member may have a surface coating that is releasable from, or resists bonding to, concrete. For example, the at least one planar member may comprise expanded plastic sheet material, such as an integral foam Polyvinyl Chloride (PVC) sheet.

The present invention also provides a kit of parts, comprising:

at least one planar member having a two- or three-dimensional surface pattern formed thereon or therein; and

a plurality of resilient spacers removably positionable on or in the surface pattern to form a surface relief pattern of spaced-apart recesses on the at least one planar member.

The present invention further provides a method, comprising:

providing a two- or three-dimensional surface pattern on or in at least one planar member; and

providing a plurality of resilient spacers that are removably positionable on or in the surface pattern to form a surface relief pattern of spaced-apart recesses on the at least one planar member.

The present invention also provides a prefabricated building panel or structure formed using the system, kit of parts or method described above.

### BRIEF DESCRIPTION OF DRAWINGS

Embodiments of the invention will now be described by way of example only with reference to the accompanying drawings, in which:

FIGS. 1 to 3 are perspective views of an example system for forming prefabricated building panels or structures according to an embodiment of the invention;

FIGS. 4 to 6 are detailed sectional views of slots and resilient spacers of the system; and

FIGS. 7 to 14 are perspective, detail and top views of various configurations of the system when assembled into a mould or placement bed for forming prefabricated building panels or structures.

### DETAILED DESCRIPTION

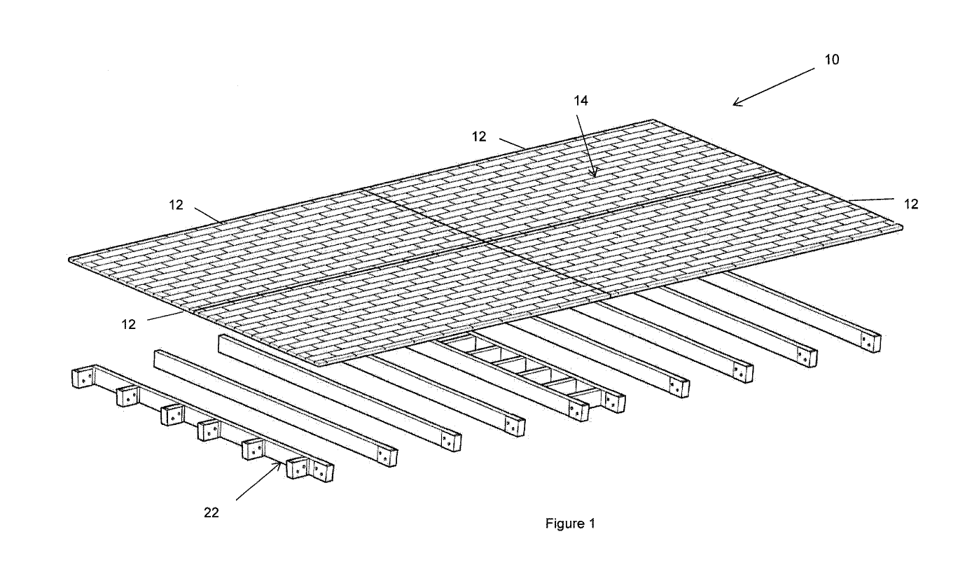

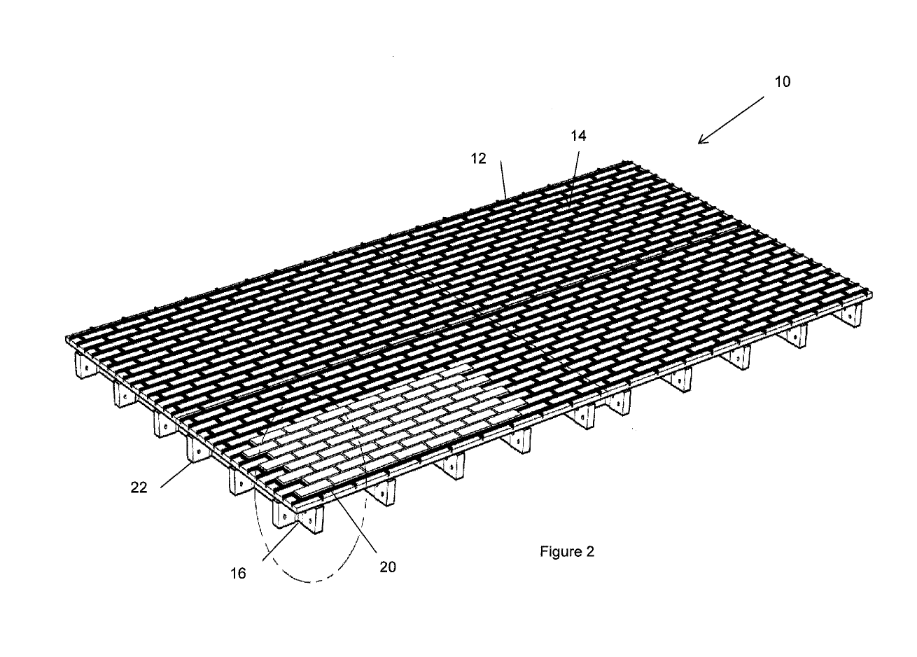

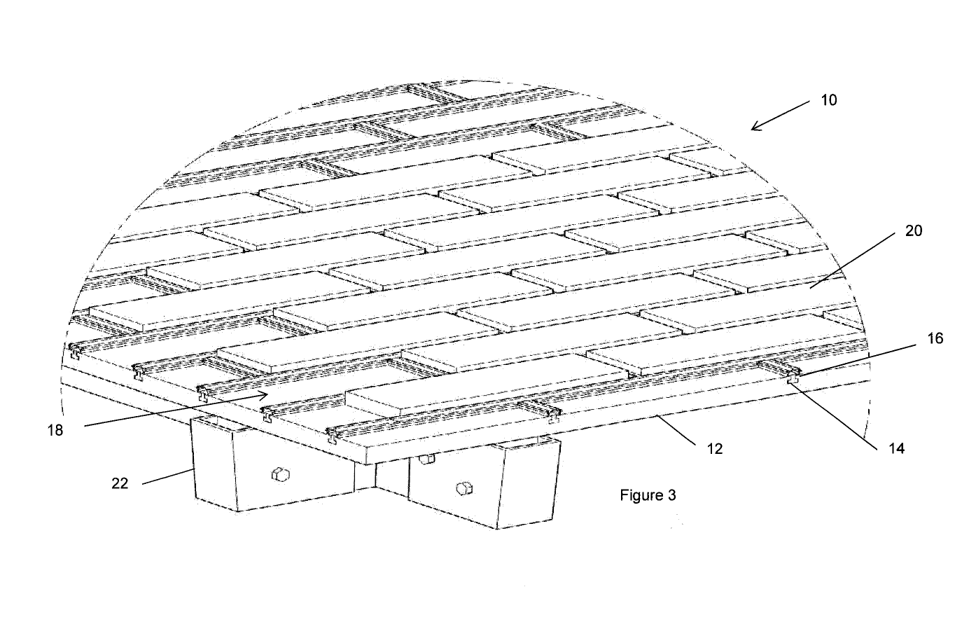

Referring to FIGS. 1 to 3, an example system 10 for forming prefabricated building panels or structures according to an embodiment of the invention may comprise at least one planar member 12 having a two- or three-dimensional surface pattern 14 formed thereon or therein. The system 10 may further comprise a plurality of resilient spacers 16 removably positionable on or in the surface pattern 14 to form a surface relief pattern of spaced-apart recesses 18 on the at least one planar member 12. The surface pattern 14 may comprise slots, and the resilient spacers 16 may comprise ribs removably receivable in the slots 14. Alternately, the surface pattern 14 may comprise surface markings, and the resilient spacers 16 may comprise self-adhesive ribs removably positionable on the surface markings. In the example embodiments illustrated in the drawings and described in detail below, the surface pattern 14 is implemented by way of example only as a surface pattern of slots 14. The at least one planar member 12 may be a plurality of horizontal planar members 12 supported on framework 22.

The planar members 12 may, for example, be wood panels, such as plywood panels. The planar members 12 may have a surface coating, such as a release film, that is releasable from, or resists bonding to, concrete. Alternatively, the at least one planar member 12 may comprise expanded plastic sheet material, such as an integral foam PVC sheet (eg, T Board or Maxi T integral Foam PVC sheets supplied by Australian Sheet Traders). Other equivalent or alternative materials may also be used. The framework 22 may comprise, for example, spaced-apart joists, such as Laminated Veneer Lumber (LVL) beams. The joists may sit on top of a concrete panel manufacturer's existing steel form bed providing a stable but floating surface for the panel manufacturer to screw the planar members 12 into. The pattern of slots 14 may be formed, for example, by Computer Numerical Control (CNC) machining.

The surface relief pattern of spaced-apart recesses 18 may be used to form prefabricated building panels 38 or structures 40 having surface relief patterns of architectural components or masonry items 20, such as bricks, tiles, mosaics, stone, glass, etc. For example, concrete may be cast over architectural components 20 prepositioned in spaced-apart recesses 18 on the planar members 12. Alternatively, the architectural components 20 may be omitted so that the surface relief pattern is formed by casting concrete directly into the recesses 18 on the planar members 12 to form a surface relief pattern that mimics the three-dimensional shape of the architectural components 20. The architectural components 20 may be generally or substantially three-dimensional architectural components or masonry items having at least one generally or substantially planar surface receivable in the recesses 18. When the planar architectural components 20 are bricks or tiles, the pattern of slots 14 may be a grid or matrix pattern. The resultant surface relief pattern cast in the prefabricated building panel 38 or structure 40 may be a three-dimensional coplanar or overlapping, shiplap brick pattern.

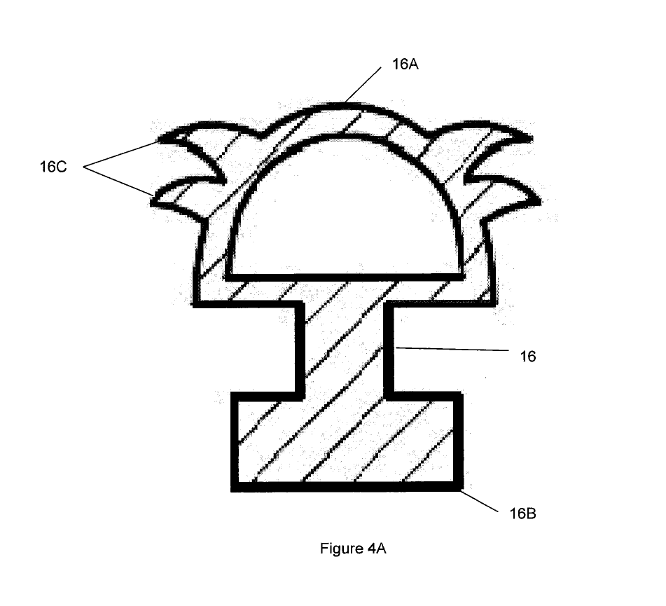

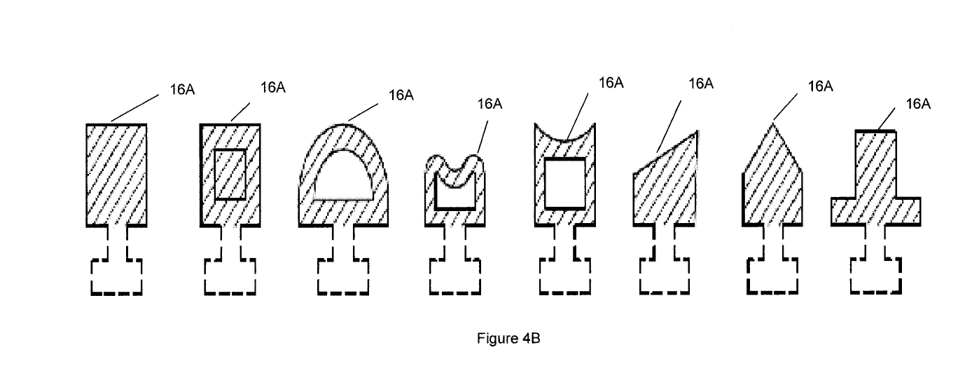

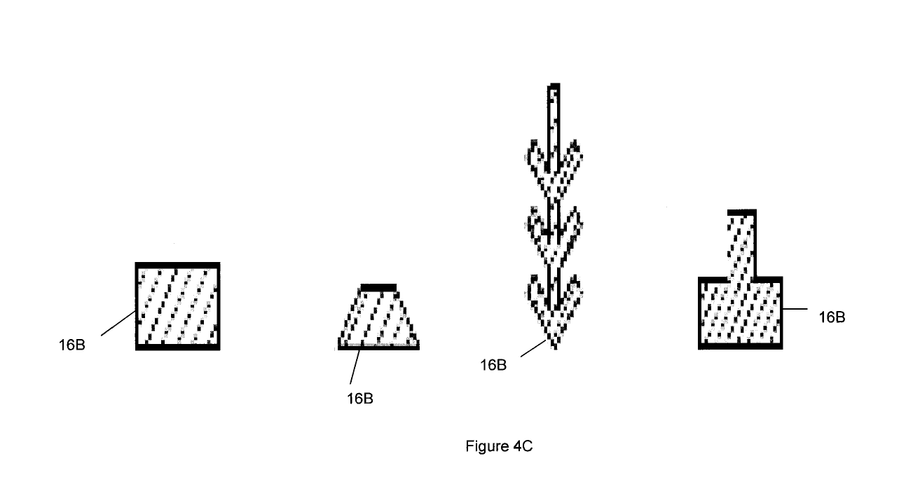

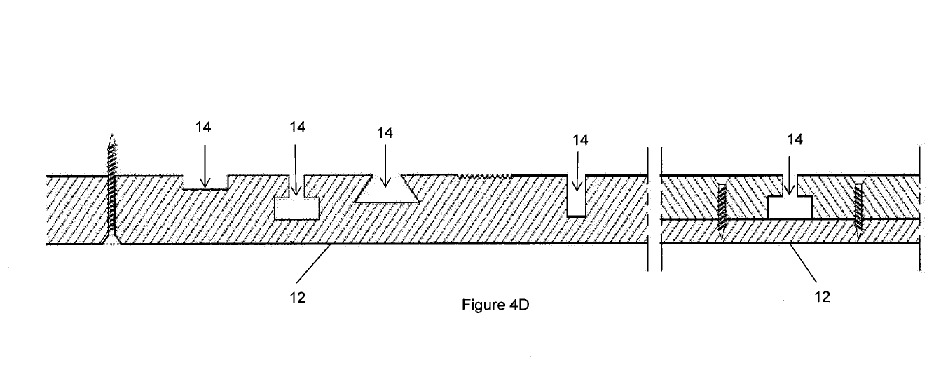

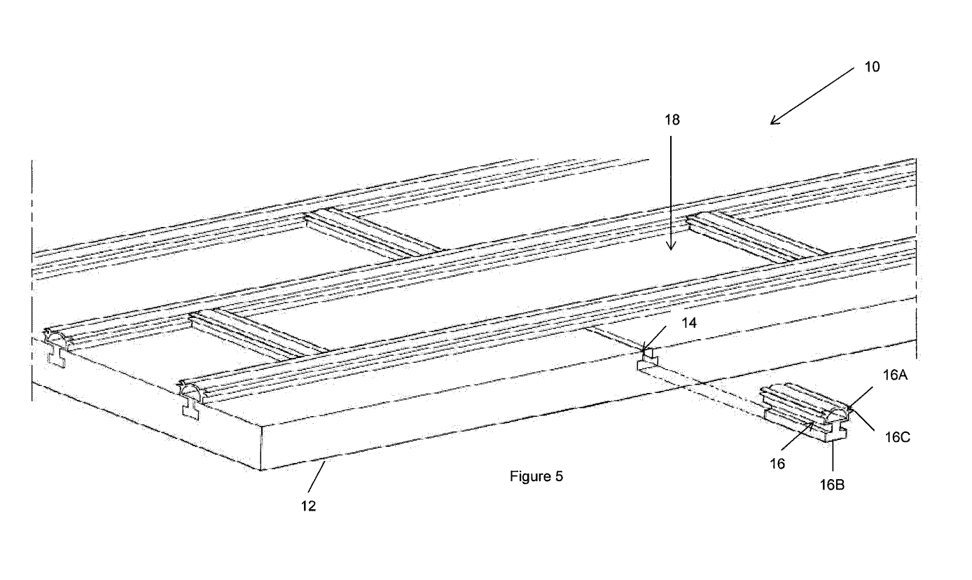

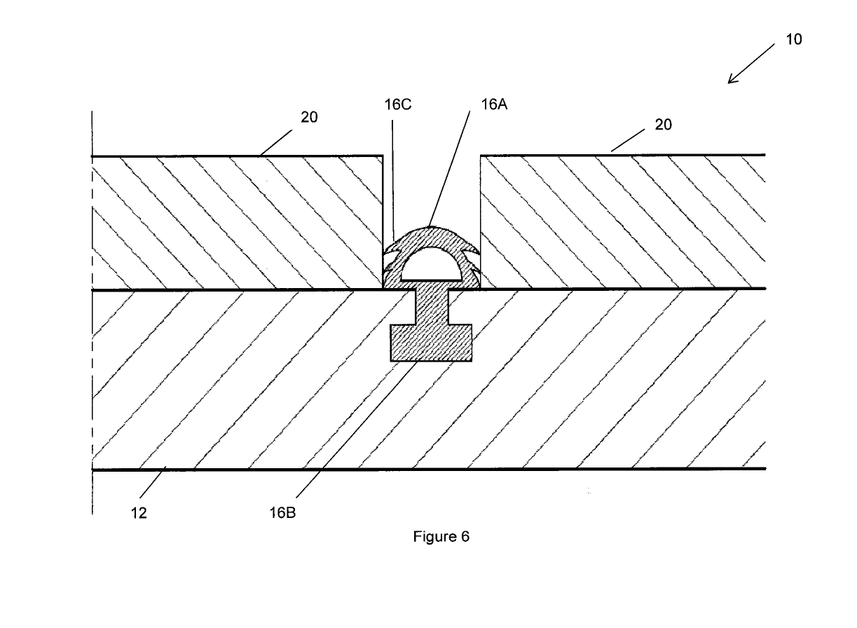

Referring to FIGS. 4 to 6, the slots 14 and the resilient spacers 16 may have complementary releasably interlocking configurations in vertical cross-section. For example, the slots 14 may be inverted T-shaped channels. As illustrated in FIG. 4D, the slots 14 may either be integrally formed on the planar member 12, or may be formed as a composite structure comprising a planar substrate with overlying spaced-apart planar members configured to define the slots 14.

Referring to FIGS. 4 to 6, each resilient spacer 16 may comprise elongate strips or ribs having a head 16A and a base 16B, wherein the base 16B has an inverted T shape that is horizontally slidable into the inverted T-shaped slots 14. Alternatively, the resilient spacers 16 may be removably receivable in the slots 14 by press fitting or friction fitting as illustrated in FIG. 4C. The head 16A of the resilient spacers 16 may be configured to resiliently and sealingly compress against a horizontally adjacent one of the planar architectural components 20, and the base 16B may be configured to be anchored in a vertically adjacent one of the slots 14. For example, the head 16A may have a hollow, semi-circular or semi-elliptical cross-section, and the base 16B may comprise one or more pairs of upward angled barbs 16C. When the planar architectural components 20 are bricks or tiles, the heads 16A of the resilient spacers 16 may define voids between adjacent bricks or tiles, such as mortar or grout joints in conventional brickwork or tiling.

As illustrated in FIGS. 4A and 4B, the head 16A of the resilient spacers 16 may be hollow so as to be elastically compressible. The hollow head 16 A may elastically deform and elongate as it is removed from the concrete thereby reducing the tension on it and the chances of it being damaged or pulled off the planar member 12. The head 16A may further comprise fir tree projections 16C to grip and retain the planar architectural components 20 against the planar members 12. FIGS. 4B to 4D illustrate further or alternative configurations of the slots 14 and the resilient spacers 16. Other equivalent configurations may also be used. The resilient spacers 16 may be cut from a strip of resilient material of indeterminate length. The resilient spacers 16 may be formed from a rubber, plastic or foam resilient material that is flexible, elastic, durable and releasable from concrete. For example, the head 16A and the base 16B of each resilient spacer 16 may be co-extruded, wherein the head 16A is formed of TPV (eg, Santoprene™), and the base 16B is formed of polypropylene. Other equivalent or alternative materials may also be used. The resilient spacers 16 may further comprise a substantially rigid spine (not shown) to strengthen and reinforce the resilient shaper 16. The substantially rigid spine may be made, for example, of a rigid plastic or metal material. The substantially rigid spine may be integrally formed with the resilient spacer 16, for example, by co-moulding, co-extrusion or overmoulding.

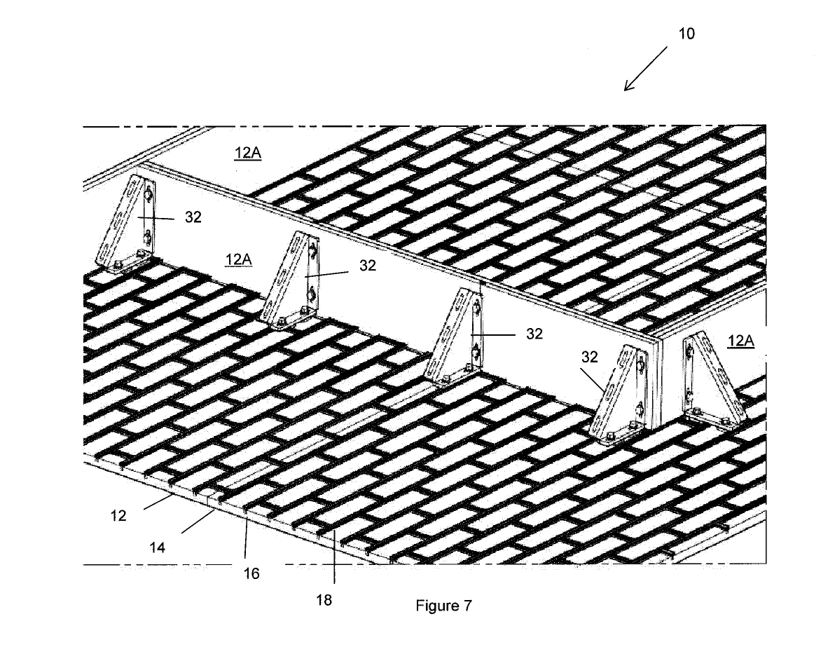

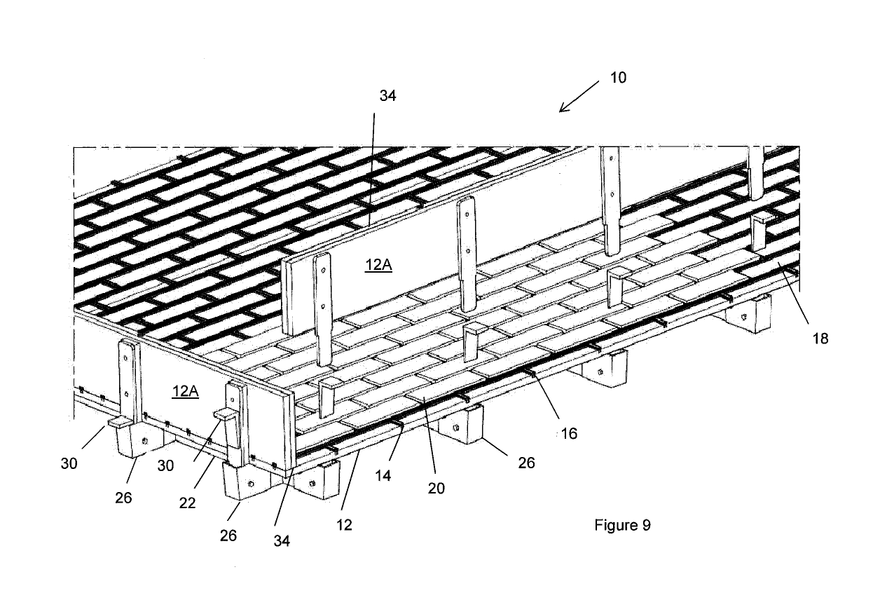

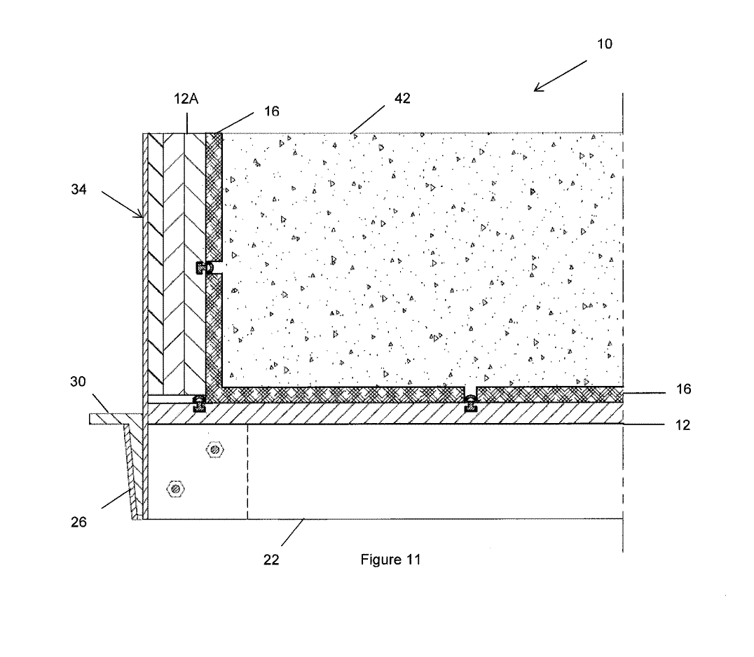

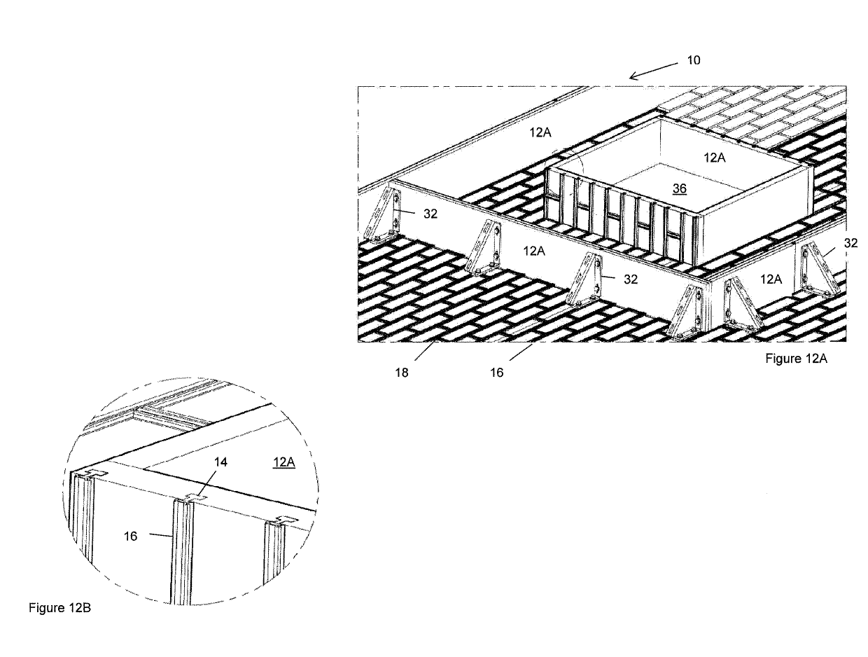

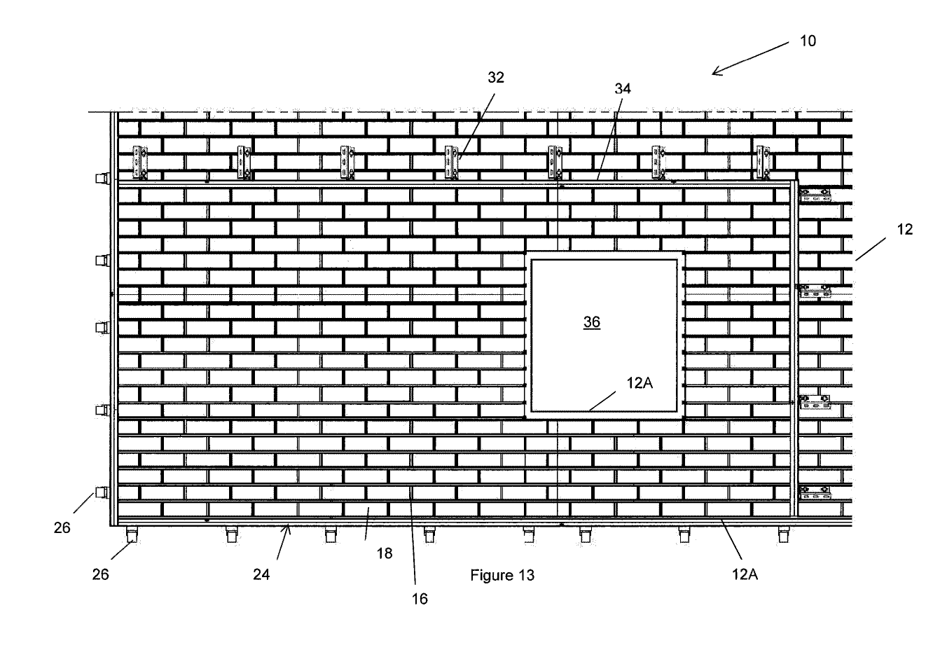

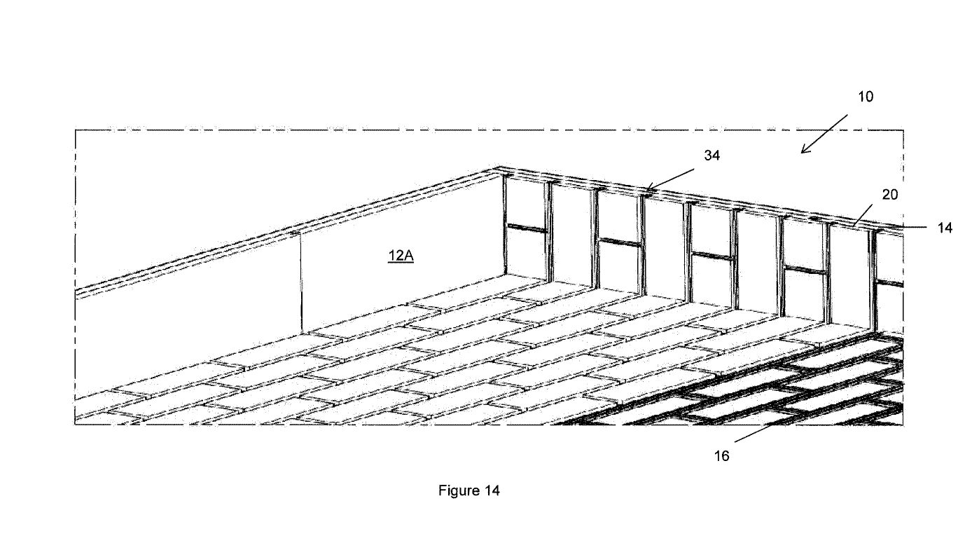

Referring to FIGS. 7 to 14, the system 10 may further comprise a horizontal planar member 12 and a plurality of vertical planar members 12A arranged in or around the horizontal planar member 12 to form a mould or placement bed 24 for receiving concrete 42 to form a flat substantially two-dimensional prefabricated building panel 38, or a three-dimensional prefabricated building structure 40. As illustrated in FIG. 9, the mould 24 may further comprise the supporting framework 22 to collectively form a placement bed (or form bed). The system 10 may be provided either as a kit of parts, or as a preassembled mould or placement bed 24.

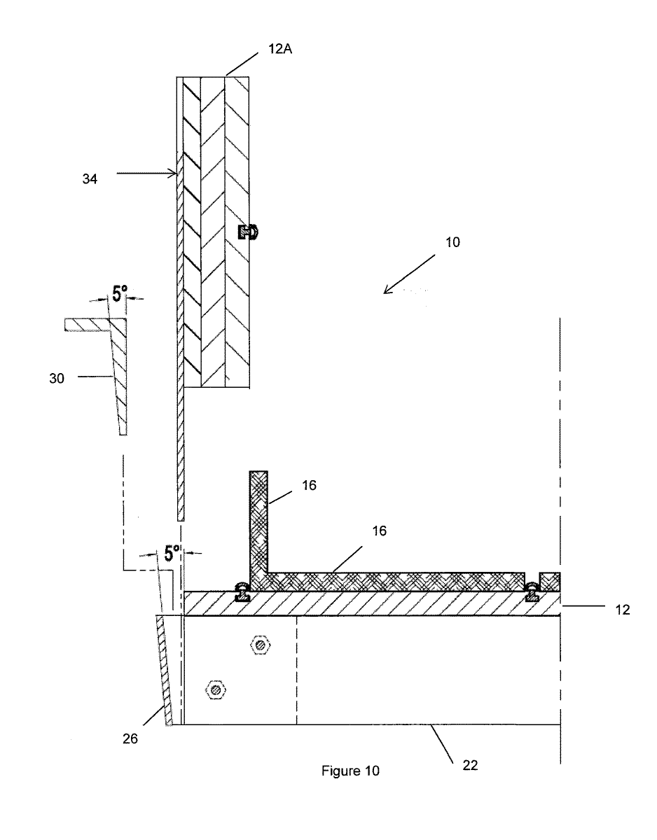

Referring to FIGS. 10 to 14, the resilient spacers 16 may be used on the horizontal planar member 12 and on any vertical or negative returns formed by the vertical planar members 12A. As illustrated in FIGS. 9 to 11, the joists of the framework 22 may be used to assist in the quick and accurate location of concrete panel perimeters or shutters 12A. The joists of the framework 22 may have holes drilled horizontally through each end to mount a joist clamp 26. The joist clamp 26 clamps a steel angle referred to as a joist shutter bracket 28 onto the joist at the edge of the framework 22. Packing 30 may be attached to the vertical face of the joist clamp 26 to locate the shutter 12A in the most desired vertical orientation position over the placement bed 24.

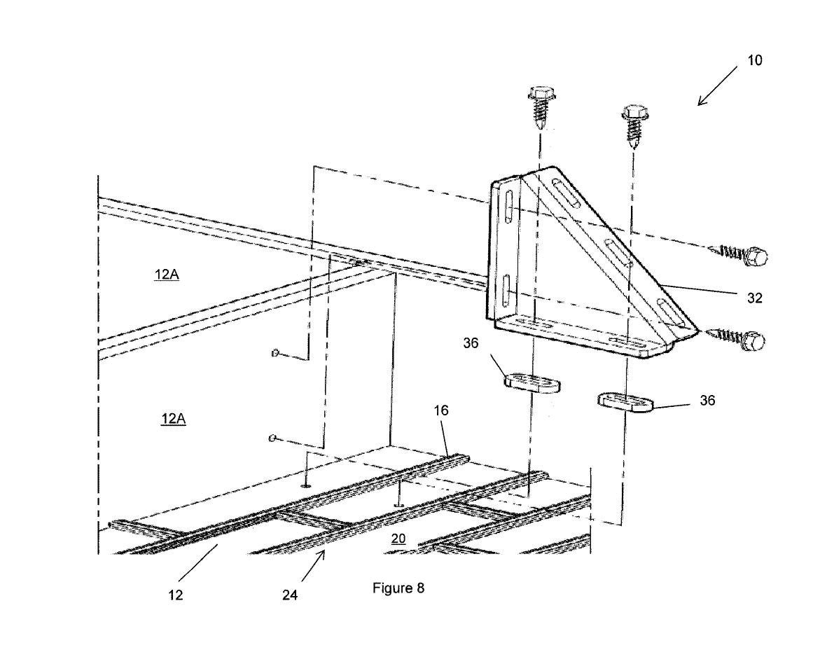

Referring to FIGS. 7 and 8, a surface shutter bracket 32 may consist of two parts that cooperate to vertically mount a vertical planar member 12A to the surface of the horizontal planar member 12. As best seen in FIGS. 10, 11 and 14, the first part may be a vertical planar member 12A with the pattern and profile of the slots 14 and resilient spacers 16 cut out of it such that it interlocks with the horizontal planar member 12 and its resilient spacers 16 to create an interlock plate 34. The second part may be an angled steel bracket 32 that is attached to the top of the interlocking horizontal planar member 12. In combination, these two parts 32, 34 may conveniently allow the quick and accurate location of a perimeter or shutter 12A in any position on top of the placement bed 24.

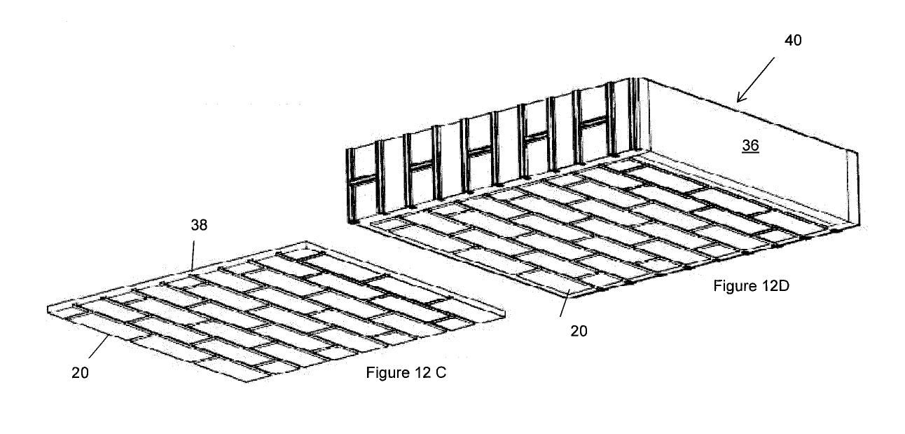

The interlock plate 34 may also be used to create voids 36 in a concrete panel 38 or structure 40 such as for doors and windows, as illustrated in FIGS. 12A,12D and 13. In addition, the edge of the interlock plate 34 may be cut on a chamfer and have avertical shutter fixed to it to create a chamfered corner of a concrete panel with the masonry items 20 running right up to the chamfer. Further, the interlock plate 34 may be used as a block-out or blanking panel so that masonry items 20 may be post-adhered to the concrete panel 38. In other words, the interlock plate 34 may comprise a reverse piece of form ply or T Board, that when placed on the liner 12 meshes with the resilient spacers 16 locating and holding it in place. Four interlock plates 34 may form a four-sided box with no top. Placed in a complementary position on the liner 12 and gently screwed down, the four-sided box may serve the purpose of voiding out windows and doors, thus reducing the time and cost of building additional shutters.

As best seen in FIG. 8, the surface shutter bracket 32 may be a steel plate folded three times to make a right angle triangle with flanges or drilled surfaces facing both the shutter 12A and the formliner 24. Self adhesive packers 36 having a thickness matching the resilient spacer strip 16 may be stuck to the base of the steel shutter bracket 28 at each end allowing its base to straddle the resilient spacer strip fitted in the placement bed 24.

Embodiments of the invention may also provide a system of adjustable length shutters 12A which is made up of shorter sections with staggered joins. Staggering the joints reduces weak points where the shorter pieces are joined to make up the required length of shutter 12A. It may be possible to make up a shutter 12A of any length, but initial lengths may be in multiples of standard masonry coursing (ie, a masonry item 20 plus a masonry joint). Prefabricated building panels 38 or structures 40 requiring bevelled edges may have off-the-shelf plastic extrusion attached to the top and bottom of the shutter 12A creating a bevel that is required in the finished panel 38.

Embodiments of the present invention provide formliner systems 10 that are useful for forming prefabricated building panels 38 and structures 40. Embodiments of the invention provide moulds or placement beds that may be delivered to customer at lower cost and in a shorter timeframe than existing systems. Embodiments of the invention provide placement beds that may be more easily removed from concrete panels by lifting gently and allowing the weight of the placement bed to gradually fall from the surface tension that holds it there. Embodiments of the placement beds of the invention provide a simpler method of erecting shutters, taking away the need to cut formliners to size and rely on carpenters for this role.

Embodiments of the placement beds may be precision cut making it easier and more accurate to lay out and ensure accuracy of the whole panel, not just the individual pieces. The materials are lighter and subsequently cheaper to transport to site and easier to handle once there. In addition, there is less material used overall, less wastage, and a greater percentage of the materials that are used are recyclable. Returns with mortar joints are more easily arranged where shutters can be easily cut to size at short notice from an inexpensive supply of suitable substrate. If the masonry units are not of the size as specified the resilient spacer strip may be replaced rather than replacing the whole formliner. Dimensional stability is provided by the base panel versus rubber mats that vary in size with temperature variation. If using a hollow section resilient spacer strip, it will elongate during stripping making it less susceptible to damage. The hollow section also allows for more variation in the size of the planar architectural components. The resilient spacer strips may be used as removable or sacrificial joint moulds on tight inside corners as during stripping they will either elongate and pull out from between the bricks, or they will pull out of the base panel. If the latter is the case, the resilient spacer strip may still be reinserted in the base panel.

The above embodiments have been described by way of example only and modifications are possible within the scope of the claims that follow.

1. A system, comprising:
at least one planar member having a two- or three-dimensional surface pattern formed thereon or therein; and
a plurality of resilient spacers removably positionable on or in the surface pattern to form a surface relief pattern of spaced-apart recesses on the at least one planar member.

2. A system according to claim 1, wherein the at least one planar member comprises a horizontal planar member and a plurality of vertical planar members arranged in or around the horizontal planar member to form a mould for receiving concrete.

3. A system according to claim 1 or 2, wherein the surface pattern comprises slots in the at least one planar member, and the resilient spacers comprise ribs removably receivable in the slots.

4. A system according to claim 1 or 2, wherein the surface pattern comprises surfaces markings on the at least one planar member, and the resilient spacers comprise self-adhesive ribs removably positionable on the surface markings.

5. A system according to claim 3, wherein the slots and the resilient spacers have complementary releasably interlocking configurations.

6. A system according to claim 5, wherein each resilient spacer comprises a head and a base, wherein the head is configured to resiliently and sealingly compress against a horizontally adjacent one of the substantially planar architectural components, and wherein the base is configured to be anchored in a vertically adjacent one of the slots.

7. A system according to claim 6, wherein the head has a hollow, semi-circular or semi-elliptical cross-section, and the base comprises one or more pairs of upward angled barbs.

8. A system according to any one of claims 5 to 7, wherein the resilient spacers are slidably receivable in the slots.

9. A system according to any one of claims 5 to 7, wherein the resilient spacers are removably receivable in the slots by press fitting or friction fitting.

10. A system according to any preceding claim, wherein the resilient spacers are cut from a strip of resilient material of indeterminate length.

11. A system according to any preceding claim, wherein the resilient spacers are formed from a rubber, plastic or foam resilient material that is flexible, elastic, durable and releasable from concrete.

12. A system according to claim 11, wherein the head and the base of each resilient spacer are co-extruded, and wherein the head is formed of thermoplastic vulcanizate (TPV), and the base is formed of polypropylene.

13. A system according to any preceding claim, wherein the at least one planar member has a surface coating that is releasable from, or resists bonding to, concrete.

14. A system according to any preceding claim, wherein the at least one planar member comprises expanded plastic sheet material.

15. A system according to claim 14, wherein the expanded plastic sheet material is an integral foam Polyvinyl Chloride (PVC) sheet.

16. A kit of parts, comprising:
at least one planar member having a two- or three-dimensional surface pattern formed thereon or therein; and
a plurality of resilient spacers removably positionable on or in the surface pattern to form a surface relief pattern of spaced-apart recesses on the at least one planar member.

17. A method, comprising:
forming a surface pattern on or in at least one planar member; and
providing a plurality of resilient spacers that are removably positionable on or in the surface pattern to form a surface relief pattern of spaced-apart recesses on the at least one planar member.

18. A prefabricated building panel or structure formed using:
a system according to any one of claims 1 to 15; or
a kit of parts according to claim 16; or
a method according to claim 17.
